(19) United States
(12) Patent Application Publication
(10) Pub. No.: US 2022/0369363 A1
(43) Pub. Date: Nov. 17, 2022

(54) AUTHENTICATION AND AUTHORIZATION TO ACCESS A NETWORK BY AN UNMANNED AERIAL VEHICLE

(71) Applicant: IDAC Holdings, Inc., Wilmington, DE (US)

(72) Inventors: Samir Ferdi, Kirkland (CA); Michelle Perras, Montreal (CA); Ahmad Saad, Montreal (CA)

(73) Assignee: IDAC Holdings, Inc., Wilmington, DE (US)

(21) Appl. No.: 17/637,718

(22) PCT Filed: Aug. 20, 2020
(86) PCT No.: PCT/US2020/047167

§ 371 Date: Feb. 23, 2022

Related U.S. Application Data
(60) Provisional application No. 62/891,093, filed on Aug. 23, 2019.

(51) Int. Cl. H04W 74/00; H04W 76/11; B64C 39/02

(52) U.S. Cl. CPC H04W 74/002; H04W 76/11; B64C 39/024; B64C 2201/122

(57) ABSTRACT

A wireless transmit/receive unit (WTRU) may be configured to support UAV authentication and/or authorization. A WTRU may obtain a UAV profile (e.g., UAV id) via registration with a network. UAV authentication and authorization may be performed with a UAS server/UTM based on the UAV profile. UAV authentication and authorization procedures may be UAS-based (e.g., via a UTM over a user plane) and/or EAP-based (e.g., via a UTM with an AMF or SMF authenticator). A WTRU may setup a PDU session, for example, for UAV authentication with a UAS server/UTM over a user plane. A WTRU may perform UAV authentication with a UAS server/UTM via AMF (e.g., EAP over NAS/MM) or via SMF (e.g., EAP over NAS/MM during PDU session establishment). A UAS id and/or UAV-C id may be received, for example, via a UCU procedure or a PDU session establishment accept message.

### CROSS-REFERENCE TO RELATED APPLICATIONS

This application claims the benefit of U.S. Provisional Application No. 62/891,093, filed Aug. 23, 2019, the contents of which are incorporated by reference herein.

### BACKGROUND

Mobile communications using wireless communication continue to evolve. A fifth generation may be referred to as 5G. A previous (e.g., legacy) generation of mobile communication may be, for example, fourth generation (4G) long term evolution (LTE).

Unmanned aerial vehicles (UAVs) are a type of wireless transmit/receive unit (WTRU) that may operate by utilizing mobile communications (e.g., 4G and/or 5G). Communications and coordination techniques by and/or between UAVs may be insufficient.

### SUMMARY

Systems, methods, and instrumentalities are described herein for WTRU authentication and authorization. A WTRU (e.g., a WTRU implemented in a UAV) may be configured to implement procedures to assist with the authentication and/or authorization of a UAV to communicate with other devices and/or to take one or more actions. For example, a WTRU may authenticate with and/or be authorized by an unmanned aerial system (UAS) server and/or the like. Messaging to support UAS authentication and/or authorization may be sent to a UAS traffic management (UTM) server, for example, over a user plane. A WTRU may obtain a UAV profile (e.g., UAV identifier (id)) via registration with a network device. A WTRU may set up a protocol data unit (PDU) session and/or authenticate with a UAS server over a user plane. A WTRU/UAV may obtain authorization to fly from a UTM, for example, over a user plane. A UAS id and/or UAV controller (UAV-C) id may be received, for example, via a WTRU/UE configuration update (UCU) procedure.

A UTM and/or other entities/functionalities may perform extensible authentication protocol (EAP) based authentication and/or authorization, for example, with an access and mobility management function (AMF) as authenticator. A WTRU may (e.g., in an EAP based authentication and/or authorization with an AMF as authenticator) obtain a UAV profile (e.g., a UAV id) via registration with a network. A UAV may exchange authentication/authorization messages with a UAS server/UTM, for example, via an AMF (e.g., using EAP over non-access-stratum (NAS)/mobility management (MM) messages). A UAS id and/or UAV-C id may be received, for example, via a UCU procedure.

A UTM and/or other entities/functionalities may perform EAP based authentication and/or authorization, for example, with a session management function (SMF) as authenticator. A WTRU may (e.g., in an EAP based authentication and/or authorization with an SMF as authenticator) obtain a UAV profile (e.g., a UAV id), for example, via registration with a network. A WTRU may trigger a PDU session establishment. A UAV may exchange authentication/authorization messages with a UAS server/UTM, for example, via an SMF (e.g., EAP over NAS/session management (SM) during PDU session establishment). A UAS id and/or UAV-C id may be received, for example, via a PDU session establishment accept message.

In examples, methods may be implemented to perform WTRU authentication and authorization. Methods may be implemented (e.g., in whole or in part), for example, by one or more devices, apparatuses, and/or systems (e.g., a WTRU, such as a UAV, a peer WTRU, such as a UAV-C, a network node or function, a UAS, a UTM, and/or the like), which may comprise one or more processors configured to execute the methods (e.g., in whole or in part) as computer executable instructions that may be stored on a computer readable medium or a computer program product, that, when executed by the one or more processors, performs the methods. The computer readable medium or the computer program product may comprise instructions that cause one or more processors to perform the methods by executing the instructions.

In examples, a registration request that comprises a UAV identifier associated with the WTRU may be sent. A registration acceptance message that comprises UAV profile information may be received. In response to the received registration acceptance message, a UAV authentication and authorization may be performed with a UAS server based on the UAV profile information. Upon the UAV authentication and authorization acceptance, a communication session may be established.

The UAV profile information may comprise, for example, at least one of: at least one allowed mission type; at least one allowed communication type; or a UAV controller identifier. The registration acceptance message may further comprise, for example, a UAV pending authentication and authorization indication, and the UAV authentication and authorization is performed in response to receiving the UAV pending authentication and authorization indication. The UAV authentication and authorization may be performed via a network control node, for example, using an EAP over NAS.

The UAV identifier and a WTRU identifier associated with the WTRU may be sent to the UAS server via an access and mobility management function (AMF). A UAS traffic management (UTM) identifier and UTM information associated with a UTM may be received. UAV authorization may be performed with the UTM, wherein the UAS server is part of the UTM. The UAS server may comprise a UAS service supplier (USS).

The UAV identifier and a WTRU identifier associated with the WTRU may be sent in a PDU session establishment request. UAV authentication and authorization may be performed with the UAS server via a session management function (SMF). A PDU session establishment acceptance message may be received from the SMF.

The PDU session establishment acceptance message may comprise, for example, a UAS communication parameter that comprises at least one of: a UAV identifier assigned by the UAS server and a UAV controller identifier. The UAV authentication and authorization may be performed further based on the UAV identifier. The UAV authentication and authorization may be performed, for example, via an SMF using a PDU session authentication procedure.

A message indicating a successful UAV authentication and authorization may be received, and may include a UAS configuration parameter that comprises, for example, at least one of: a UAV identifier assigned by the UAS server, a UAV controller identifier, or UTM information. The communication session may be established using the received UAS configuration.

A network control node may be configured to connect a WTRU to a network. The network control node may comprise a processor configured (e.g., programmed with executable instructions to implement a method) to: receive a network registration request from the WTRU that comprises a UAV identifier associated with the WTRU; determine that the WTRU is associated with unmanned aerial access; obtain a UAV profile associated with the WTRU; and include the UAV profile associated with the WTRU in a registration acceptance message to the WTRU.

Whether the WTRU is associated with unmanned aerial access may be determined based on a network subscription associated with the WTRU. The network registration request may further comprise, for example, a UAV capability indication. Whether the WTRU is associated with unmanned aerial access may be determined based on the UAV capability indication, a network subscription, and a UAV identifier associated with the WTRU.

Upon determining that the WTRU is associated with the unmanned aerial access, a UAV pending authentication indication may be included in the registration acceptance message to the WTRU. A UAV authentication and authorization procedure of the WTRU may be performed using a UAV identifier from the WTRU.

Upon a successful UAV authentication and authorization procedure of the WTRU, a UAV authorization information parameter may be received from a UAS server. The UAV authorization information parameter may include at least one of: a UAV identifier assigned by the UAS server and a UAV controller identifier, and send the UAV authorization information parameter to the WTRU.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of UAS interaction with a network and UTM authorization.

FIG. 3 illustrates an example of a system architecture for UAS support.

FIG. 4 illustrates an example of UAS communications.

FIG. 5 illustrates an example of user plane authentication and authorization by a UAS server/UTM.

FIG. 6 illustrates an example of EAP based authentication and/or authorization by a UAS server and/or a UTM with an AMF as authenticator.

FIG. 7 illustrates an example of EAP based authentication and/or authorization by a UTM via an SMF as authenticator.

FIG. 8 illustrates an example of a method for performing UAV authentication and authorization.

FIG. 9 illustrates an example of a method for performing UAV registration.

### DETAILED DESCRIPTION

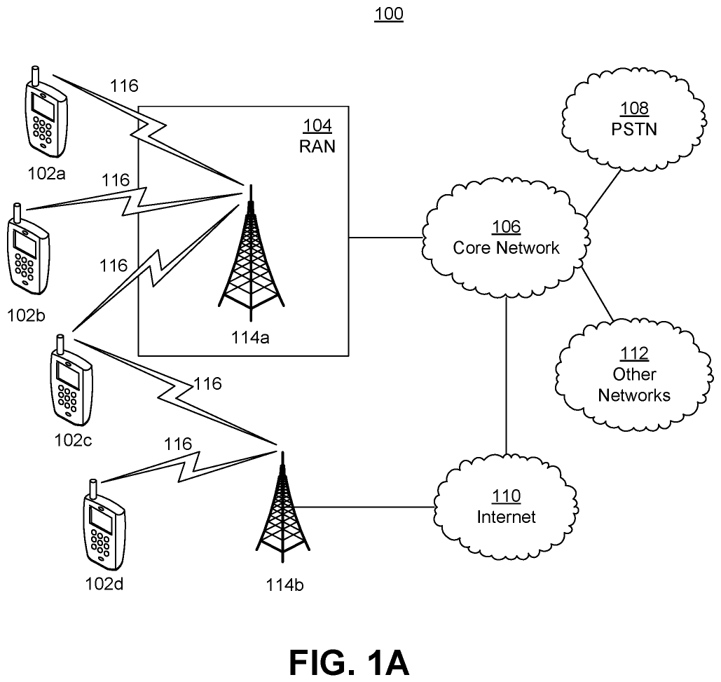

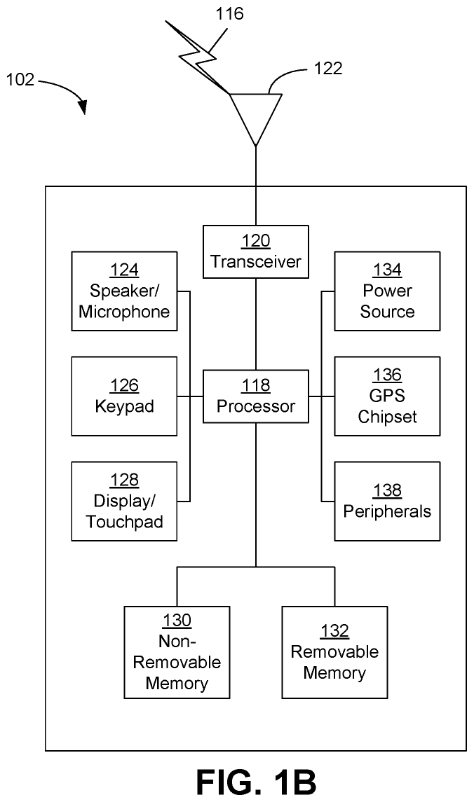

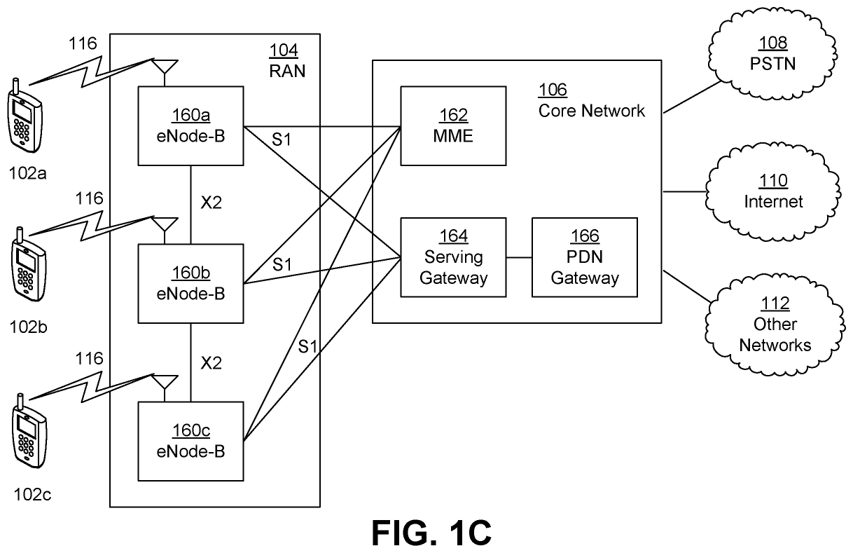

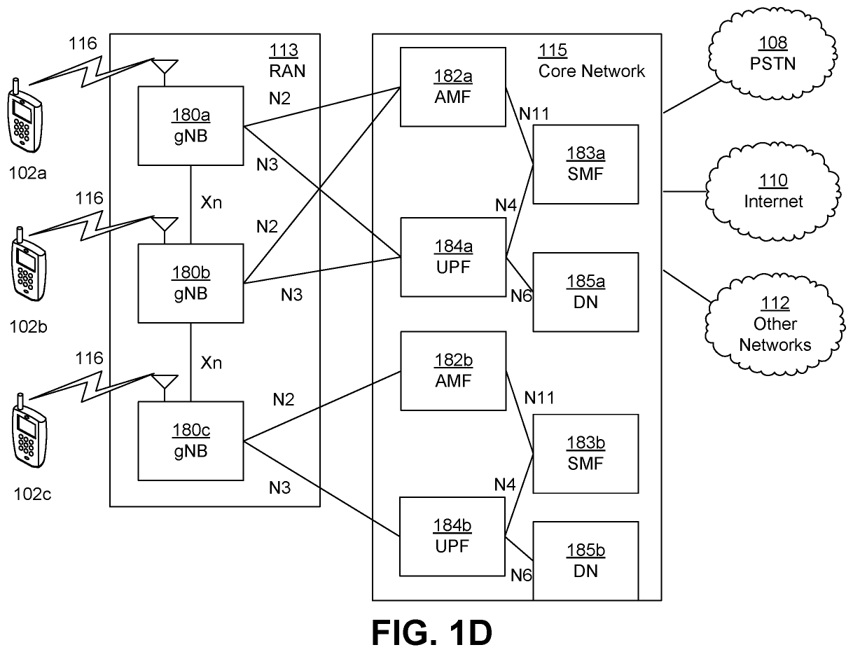

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11 ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Unmanned aerial systems (UAS) support may be used in one or more of the following: UAS remote identification and/or authorization, UAS command and control (C2) communications; unmanned aerial vehicle (UAV) navigation by a UAV controller (UAV-C) or by a UAS traffic management (UTM); and/or change of UAV-C during a flight mission.

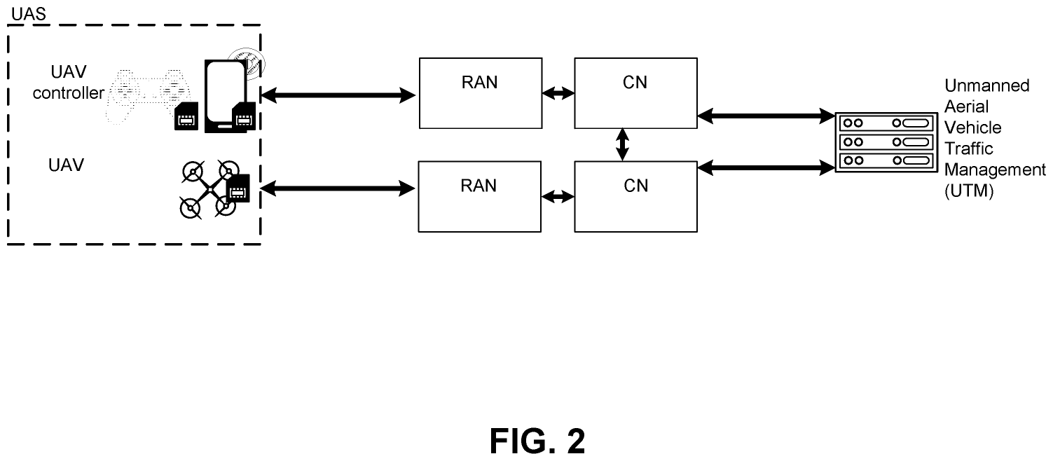

A UAS may comprise, for example, a UAV (e.g., a drone) and a UAV-C (e.g., as illustrated by example in FIG. 2). The terms UAV (e.g., and the like) and WTRU may be used interchangeably. Examples described with respect to UAVs may be applicable to other types of WTRUs that are not implemented as UAVs.

FIG. 2 illustrates an example of UAS interaction with a network and UTM authorization. Communications capabilities may be provided between a UAV and a UAV controller, which may communicate through the same or different RAN nodes and/or public land mobile networks (PLMNs). A UTM may, for example, provide UAS identification and tracking, authorization, enforcement, regulation of UAS operations, and/or storage (e.g., to store data for UAS(s) to operate).

A WTRU and/or network node may be configured to implement procedures for authentication and/or authorization with/by a third party. Procedures for authentication and/or authorization with/by a third party may include, for example, a network slice-specific authentication and authorization (NSSAA) procedure. A WTRU and/or a network node may be configured to implement an NSSAA procedure. A WTRU may (e.g., following a primary authentication) perform an NSSAA through the AMF, for example, with a third party authentication, authorization, and accounting (AAA) server (e.g., using various credentials). A WTRU may perform an NSSAA, for example, for a (e.g., each) single network slice selection assistance information (S-NSSAI) (e.g., in a requested NSSAI) that may be subject to the NSSAA. A network (e.g., AMF) may determine which S-NSSAI to perform an NSSAA for, for example, based on one or more of WTRU capability to perform NSSAA, subscription information, and operator policy. A network may trigger an extensible authentication protocol (EAP) based authentication procedure(s) with a WTRU (e.g., following a registration procedure), for example, for one or more (e.g., all) applicable S-NSSAIs. An AMF may act as an authenticator in an EAP authentication between a WTRU and a third party AAA server. An S-NSSAI may be added to allowed NSSAIs in a WTRU configuration (e.g., via a UE configuration update (UCU) procedure), for example, if the WTRU is successfully authenticated for the S-NSSAI.

Procedures for authentication and/or authorization with/by a third party may include secondary authorization/authentication by a data network (DN)-AAA server. A WTRU and/or network node may be configured to implement a secondary authentication/authorization by a DN-AAA server, for example, during the establishment of a PDU session procedure. A WTRU may (e.g., during a PDU session establishment) send authentication/authorization information corresponding to a DN-specific identity to an SMF, which may determine that authentication/authorization is to be used, for example, based on an SMF policy associated with the DN. Authentication between a WTRU and DN-AAA may be performed, for example, using an EAP protocol, e.g., with the SMF acting as the authenticator. A PDU session establishment may be accepted, for example, if a WTRU is successfully authenticated. A PDU session establishment may be rejected, for example, if a WTRU is not successfully authenticated.

UTM may be used and/or configured to perform authentication/authorization of a UAS. A final authorization for flight operation from UTM may be obtained and/or enforced. A mobile network operator (MNO) may (e.g., be enabled to) allow a UAS authorization request, for example, if appropriate subscription information is present. A UAS may (e.g., be enabled to) send different UAS data to UTM, for example, based on different authentication and authorizations levels that may be applied to the UAS. UTM may (e.g., be enabled to) inform an MNO of the outcome of an authorization to operate.

An MNO may (e.g., after an initial authentication and authorization of a UAV/UAV-C based on various credentials) perform a secondary check with UTM using credentials (e.g., UAV owner certificate, UAV operator certificate), for example, to obtain authorization for a UAV to fly. A secondary check may include one or more authentication and/or authorization exchanges, for example, subject to regulatory requirements and/or depending on whether one or more UTM services (e.g., flight monitoring) are activated. A protocol for additional (e.g., secondary) authentication and authorization may consider/evaluate (e.g., be based on) different potential deployments for a UTM, which may be deployed, for example, as part of core network (CN) functionality (e.g., 5G core (5GC)) and/or as an external/third party functional entity (e.g., an entity operated by air traffic control agencies).

One or more examples described herein may be applicable to WTRUs, UAVs, and/or UAV-Cs. In one or more of the examples herein, it may be assumed, unless explicitly mentioned otherwise, that the UAV and/or UAV-C are equipped with a WTRU having UAS communications capabilities. WTRU and UAV may be used interchangeably. WTRU and UAV-C may be used interchangeably.

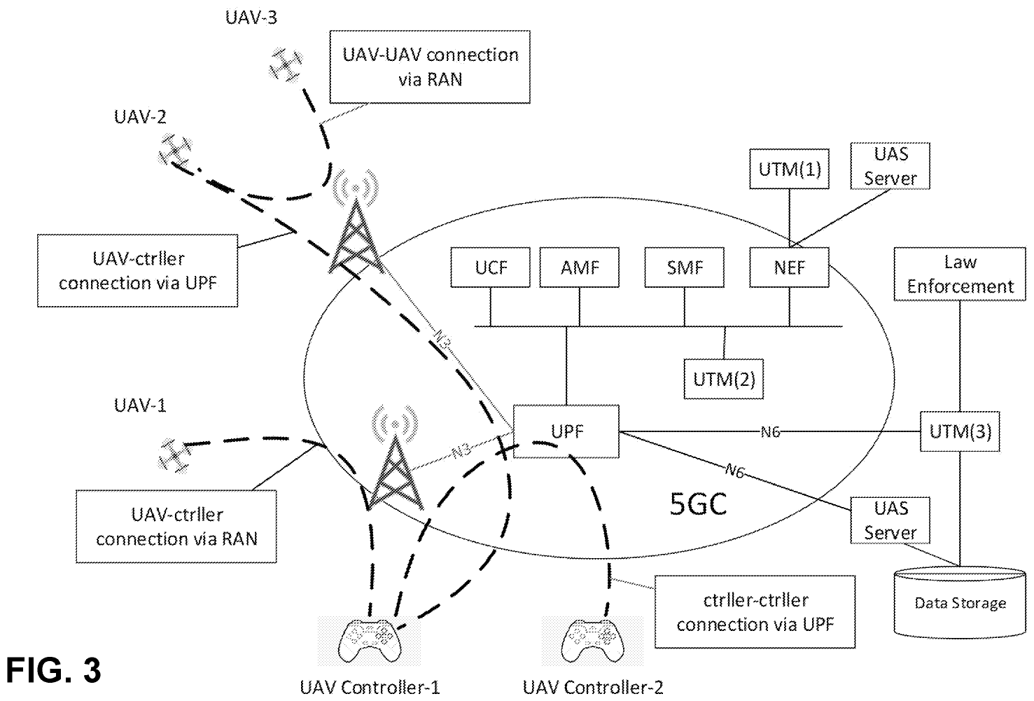

A system architecture may be configured to support interactions between different entities and/or functionalities, for example, using network communication services. FIG. 3 illustrates an example of a system architecture for UAS support (e.g., in 5G). One or more of the following may be shown in the example of system architecture in FIG. 3.

A UAV-C may control a UAV via a UPF and/or a RAN. For example, a UAV-C may control a UAV using a network assisted command and control (C2) communication service via a UPF and/or a RAN.

A UAV-C may control one or more UAVs. For example, a UAV-C may control one or more UAVs using a network C2 communication service.

A UTM may be deployed, for example, according to one or more of the following examples. In an example, a UTM may be deployed/implemented within a CN (e.g., 5GC). As shown in FIG. 3, UTM-2 may be deployed within the 5GC. In an example, the UTM may be deployed/implemented as an external function. As shown in FIG. 3, UTM-3 may be deployed as an external function (e.g., accessible via an N6 data path). In an example, a UTM may be deployed/implemented as an external function that may interface with a network exposure function (NEF). As shown in FIG. 3, UTM-1 may be deployed as an external function that can interface with a network exposure function. Examples provided herein are not mutually exclusive. For example, an external UTM may have multiple interfaces with a network (e.g., via NEF and N6). A UAS server may provide one or more of the UTM functionalities. For example, a subset of the UTM functionality may be provided by a UAS server (e.g., from a UAS service supplier (USS)). A UAV/UAV-C may communicate with a USS. For example, a UAV/UAV-C may communicate with a USS, which may be part of a UTM ecosystem. A UAS server may perform authentication and/or authorization of a UAV. For example, a UAS server may perform authentication and authorization of a UAV for UAS operations (e.g., in compliance with UTM operational requirements).

A UAV control function (UCF) may enable UAS supporting functionality, such as one or more of provisioning, authorization, tracking, and/or the like. A UCF or one or more UCF functions may be co-located. For example, a UCF or one or more UCF functions may be co-located within other functions, such as one or more of an AMF, an SMF, a policy control function (PCF), NEF, and/or the like.

A network may provide a transport for application data traffic. For example, a network may provide a transport for application data traffic between a UAV/UAV-C and a UTM. An example network may be a 3GPP network.

UAV-C to UAV-C communications may be enabled via a network. An example network may be a 3GPP network.

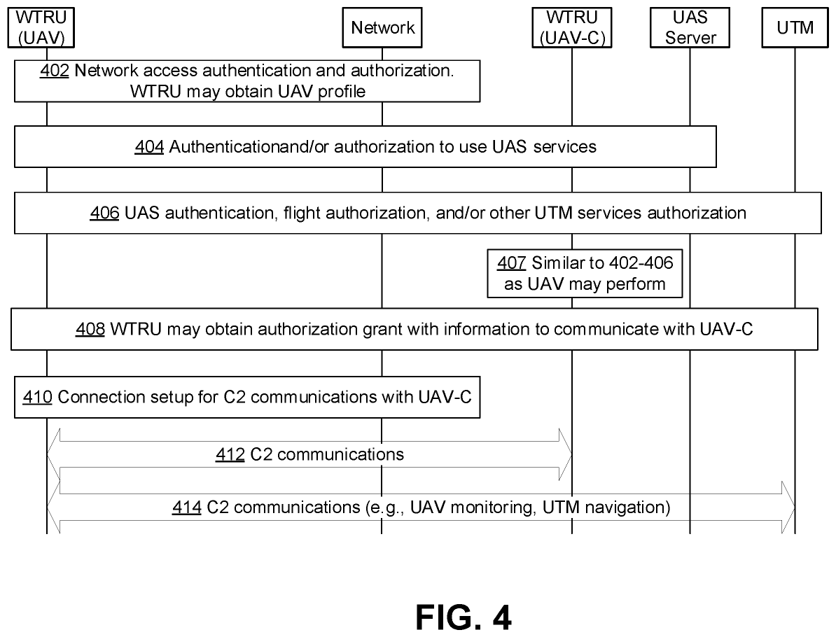

UAS communications may include one or more phases. FIG. 4 illustrates an example of the various phases for UAS communications. As shown in FIG. 4, at 402, a WTRU (or UAV) may perform authentication and/or authorization. An example of 402 may include a WTRU (or UAV) performing an initial authentication and authorization procedure for network access. The WTRU may obtain a UAV profile. For example, the WTRU may obtain a UAV profile including, for example, one or more of UAV id, type of communication allowed, list of allowed mission types, and/or the like. At 404, a WTRU may perform authentication and/or authorization to use UAS services. An example of 404 may include a WTRU performing an additional authentication and authorization procedure with a UAS Server for authorization to use UAS services. At 406, a WTRU may perform UAS authentication, flight authorization, and/or other UTM services authorization. An example of 406 may include a WTRU performing an additional procedure with a UTM for UAV authentication, flight plan authorization, and/or other UTM services authorization. At 407, a UAV-C may perform one or more of 402-406, for example, similar to 402-406 performed by a WTRU/UAV. The UAV-C may perform one or more 402-406, for example, similar to what UAV performed prior to pairing. A WTRU may be paired with a UAV controller (UAV-C), for example, by the UTM (e.g., based on completion of 402-407). A pairing may be performed in one or more ways. At 408, a WTRU may obtain an authorization grant, for example, with information to communicate with a UAV-C. An example of 408 may include a WTRU receiving a final authorization grant notification. The WTRU/UAV may be authorized to fly. At 410, a connection may be set up, for example, for C2 communications with UAV-C. An example of 410 may include a WTRU (e.g., UAV) establishing a network connection with UAV-C for C2 communications. At 412, a WTRU (e.g., UAV) may exchange C2 data traffic with a UAV-C. At 414, a WTRU (e.g., UAV) may exchange C2 data traffic with a UTM (e.g., UAV monitoring, UTM navigation, and/or the like). In an example, a WTRU (e.g., UAV) may exchange other types of UTM application data.

One or more of 402-410 may be performed in different orders and/or with fewer or additional phases of communication. In examples, UAS communications (e.g., as shown by example in FIG. 4) may be implemented in a reverse order, e.g., where a UAV-C may request authorization for UAS operations first.

In one or more examples, a WTRU id may identify a 3GPP capable device (e.g., international mobile subscriber identity (IMSI) or mobile station international subscriber directory number (MSISDN)). An example of a WTRU id may include a UAV WTRU id. WTRU id and UAV WTRU id may be used interchangeably herein.

In one or more examples, a UAV id may identify a UAV capable device (e.g., a drone). For example, a UAV id may include one or more of a generic public subscription identifier (GPSI), such as an MSISDN or an external identifier provided by a UAS system or a manufacturer serial number (e.g., a permanent equipment identifier (PEI), such as an international mobile equipment identity (IMEI) or MAC address), provisioned by a UAV device or known (e.g., being aware of) by the UAV device.

A UAV WTRU id may identify the cellular modem of a UAV. For example, a UAV WTRU id may include a subscription permanent identifier (SUPI), an IMSI, and/or an MSISDN.

A UAS id may identify a UAS (e.g., a UAV-UAV controller binding). In examples, a UAS id may be allocated by a UTM or a UAS server (e.g., external to 3GPP network). A UAS id may comprise (e.g., may be or may include) a civil aviation authority (CAA) level UAV ID.

UAS authentication and/or authorization by a UTM over user plane may include various functionalities and/or communications among one or more of a network, a WTRU, a UAS server, and/or the like.

A network may enable application layer communications between a WTRU and a UAS server/UTM for UAS operations. For example, a network may enable direct application layer communications between a WTRU and a UAS server/UTM for authentication and/or authorization for UAS operations. A UAS server may inform a network about the outcome of authorization. For example, a UAS server may inform a network about the outcome of authorization via a direct signaling interface. An example of a direct signaling interface may include, for example, a network exposure function (NEF).

WTRU (e.g., UAV) registration, authentication, authorization, and/or C2 communication may include various functional behaviors accomplished alone or in combination (e.g., via interaction).

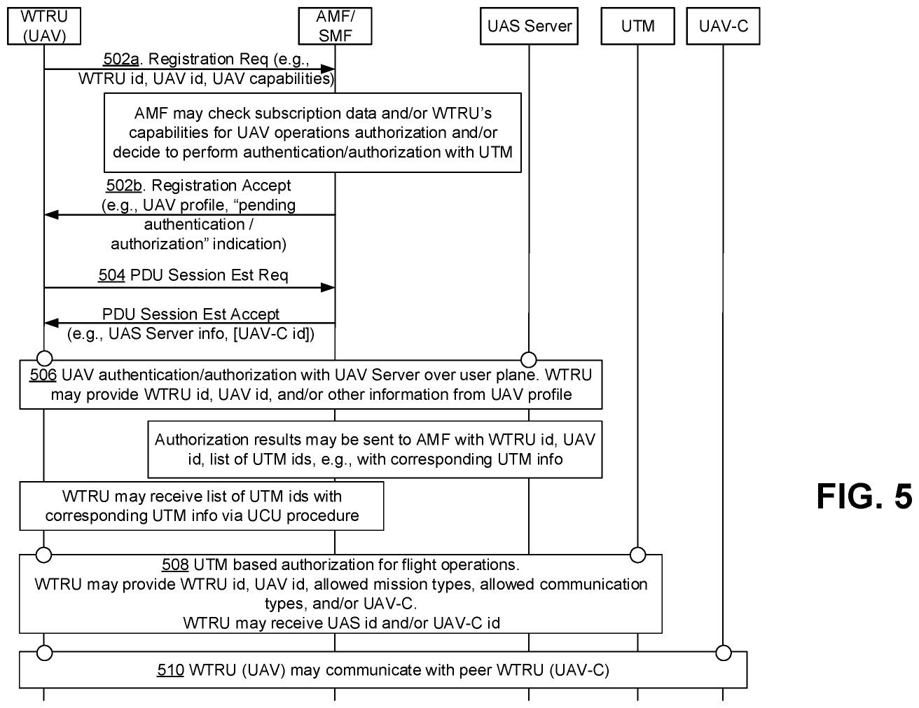

FIG. 5 illustrates an example of user plane authentication and authorization by a UAS server/UTM. As shown by example in FIG. 5, at 502, a WTRU may perform a registration procedure with a network.

A WTRU may send a Registration Request message. As shown in FIG. 5, at 502a, the WTRU may send a registration request message, which may include one or more of a WTRU id, a UAV id, UAV capabilities, and/or the like. The UAV id may be security protected. The UAV id may be sent during registration. For example, the UAV id may be sent during the registration procedure, e.g., once the security protection is established. Information regarding a WTRU's support for communication capabilities may be sent during registration. For example, a WTRU may be configured to send information regarding the WTRU's support for communication capabilities designed for UAS operation, e.g., including UAV capabilities. In an example, UAV capabilities may be UAV client enabled.

A network may send a registration accept message. The network (e.g., via an AMF implemented by the network) may obtain a WTRU profile, for example, via a unified data management (UDM), and/or may validate that UAS functionality is allowed. As shown by example in FIG. 5, at 502b, an AMF may reply with a registration accept message, which may include a UAV profile corresponding to the UAV id, a code, and/or other information. A registration accept message may (e.g., additionally and/or alternatively) include, for example, a UAV profile (e.g., corresponding to a UAV id used by the WTRU to reach the UAS server), and an indication (e.g., a code) indicating (e.g., set to), for example, “additional authentication/authorization pending.” A UAV profile corresponding to the UAV id may include, for example, a UAV id, a type of communication allowed, and/or a list of allowed mission types. In an example, AMF may reply with a Registration Accept message including a UAV profile corresponding to the UAV id including UAV id, type of communication allowed including one or more of UAV to UAV-C, UAV to UAV, and/or the like and list of allowed mission types including one or more of group mission, standalone mission, short-duration, long-duration, and/or the like, and a code set to “additional authentication/authorization pending.” The WTRU may be authorized to access the network, for example, at 502 (e.g., at the end or successful completion of 502).

A WTRU may set up a PDU session (e.g., during WTRU (UAV) registration, authentication, authorization, and/or C2 communication). A WTRU may set up a PDU session, for example, for authentication and/or authorization with a UAS server. As shown by example in FIG. 5, at 504, a WTRU may send a PDU session establishment request message (e.g., to a network, represented by an AMF/SMF implemented by the network). The WTRU may receive a PDU session establishment accept message. As shown by example in FIG. 5, a PDU session establishment accept message may include one or more of UAS Server information, a UAV-C id, and/or the like. In an example (e.g., if successful), a PDU session establishment accept message (e.g., received by a WTRU) may include UAS server information (e.g., an internet protocol (IP) address or a fully qualified domain name (FQDN)), which may be used by the WTRU to reach (e.g., communicate with) the UAS server. A PDU session establishment accept message may include the identifier(s) of one or more target peer WTRUs (e.g., a UAV-C and/or other WTRU(s)), for example, if specified in a UDM. In an example (e.g., if specified in the UDM), identifier(s) of a target peer WTRU (e.g., a UAV-C) specified in a PDU session establishment accept message may include, for example, one or more of GPSI, PEI, and/or the like.

At 504 (e.g., at the end or successful completion of 502), a secure communication may be established between the WTRU and the UAS server. At 504 (e.g., at the end or successful completion of 504), the WTRU may start an authentication and/or authorization procedure with the UAS server.

A WTRU may authenticate with the UAS server over the user plane (e.g., during WTRU (UAV) registration, authentication, authorization, and/or C2 communication). As shown by example in FIG. 5, at 506, the WTRU may authenticate/authorize with the UAS server over the user plane using the PDU session established at 504. Application level messages may be exchanged, for example, during authentication and/or authorization with the UAS server over the user plane using the PDU session. The WTRU may provide (e.g., to a UAS server), for example, a WTRU id, a UAV id, and/or other information from a UAV profile. In an example (e.g., for the authentication and/or authorization), the WTRU may specify (e.g., indicate, provide or include in one or more messages), for example, one or more of its WTRU id, UAV id, list of one or more allowed mission types, and/or one or more allowed communication types. In examples, a UAV id may include one or more of GPSI, PEI, and/or the like. The WTRU may (e.g., also) specify (e.g., by one or more identifiers) one or more of the WTRU's target peer WTRUs (e.g., UAV-C). In examples, a WTRU may specify (e.g., if available) one or more identifiers (e.g., one or more of GPSI, PEI, and/or the like) for the one or more target peer WTRUs (e.g., UAV-C).

A UAS server may inform the network (e.g., via an AMF/SMF implemented by the network) that a WTRU is authorized as a UAV-capable WTRU, for example, upon successful authentication and authorization with the UAS Server. A UAS server may send the results of an authorization attempt (e.g., an authorization result) to the network. An authorization result (e.g., communicated to a server) may include, for example, one or more of a WTRU id, a UAV id, a list of UTM ids with UTM information, and/or the like. As shown by example in FIG. 5, at 506, the UAS server may send the authorization result to an AMF (e.g., via NEF), for example, with (e.g., including, indicating, specifying) one or more of a WTRU id, a UAV id, a list of UTM ids with corresponding UTM information, and/or the like. The UAS server may (e.g., if the authorization is successful) send (e.g., in the authorization result with the list of UTM ids) related UTM information (e.g., a list of UTM information) to reach (e.g. access) the UTM(s)).

A WTRU may receive a list of UTM ids with related UTM information from the network (e.g., via an AMF implemented by the network). As shown by example in FIG. 5, at 506, the WTRU may receive a list of UTM ids with corresponding UTM information (e.g., via a UCU procedure). The (e.g., list of) UTM information may include, for example, geographies supported by the UTMs and/or associations between UTMs and one or more mobile network operators (MNOs). In some examples, an NAS layer on the WTRU may obtain the list of UTM ids and related UTM information (e.g., directly) from the application layer.

The WTRU may be authorized as a UAV capable WTRU at 506 (e.g., at the end or successful completion of 506). For example, WTRU may be authorized to use UAS services. A WTRU may engage in further authentication/authorization with a UTM, for example, for flight authorization, and/or the like.

A WTRU (e.g., UAV) may (e.g., during registration, authentication/authorization, and/or C2 communication) contact a UTM. The WTRU may contact a UTM from the received list of UTMs (e.g., for the final UAS related authorization steps using the established or current PDU session). As shown by example in FIG. 5, at 508, UTM based authorization for flight operations may be performed. At 508, the WTRU may provide, for example, one or more of the following: its WTRU id, a UAV id, the list of allowed mission types, the allowed communication types, the UAV-C id (e.g., if available), and/or the like. The WTRU may be paired with a UAV controller (UAV-C). The WTRU may obtain information (e.g., a UAS id and/or a UAV-C id) to (e.g., be used to) communicate with the (e.g., paired) UAV controller. As shown by example in FIG. 5, at 508, the WTRU may receive a UAS id and/or a UAV-C id. At 508 (e.g., at the end of or successful completion of 508), the WTRU may be authorized to fly.

A WTRU (e.g., UAV) may (e.g., during registration, authentication/authorization, and/or C2 communication) modify a PDU session and/or set up a different PDU session, for example, for C2 communications with a target peer WTRU (e.g., UAV-C). As shown by example in FIG. 5, at 510, a WTRU may communicate with a peer WTRU (e.g., UAV-C). The WTRU may communicate with a peer WTRU (e.g., UAV-C), for example, using the UAV-C id and UAS id, e.g., via the different or modified PDU session.

EAP based authentication and/or authorization may be performed by a UTM and/or other entities/functionalities, for example, using an AMF as an authenticator. In one or more examples herein, the network may (e.g., be enabled to) pair multiple WTRUs (e.g., two WTRUs). In examples, a network (e.g., via an AMF) may pair a UAV and a UAV-C to engage in C2 communications. A UTM may perform the UAV authentication, for example, directly and/or through a separate AAA server (e.g., in front/connected to a UTM). In one or more examples, a UTM may act as a third-party AAA server or may be in communication with a third-party AAA server. A UTM may be network slicing agnostic. A WTRU and/or a network may skip sending (e.g., in EAP messages) slicing information (e.g., S-NSSAI) with a UTM. A third-party AAA server (e.g., in an NSSAA procedure) may behave differently. An operator may allocate one or more dedicated network slices (e.g., customized for C2 communications) for a particular UTM. A UAV and/or UAV-C may be configured to access independent network slices, and/or the network slices may be (e.g., independently) authenticated, for example, using an NSSAA procedure for network slices associated with a particular UTM.

EAP based authentication and/or authorization may include, for example, one or more of the following: WTRU (e.g., UAV) initial registration, WTRU (e.g., UAV) EAP authentication/authorization, WTRU (e.g., UAV) setup for C2 communications, and/or the like.

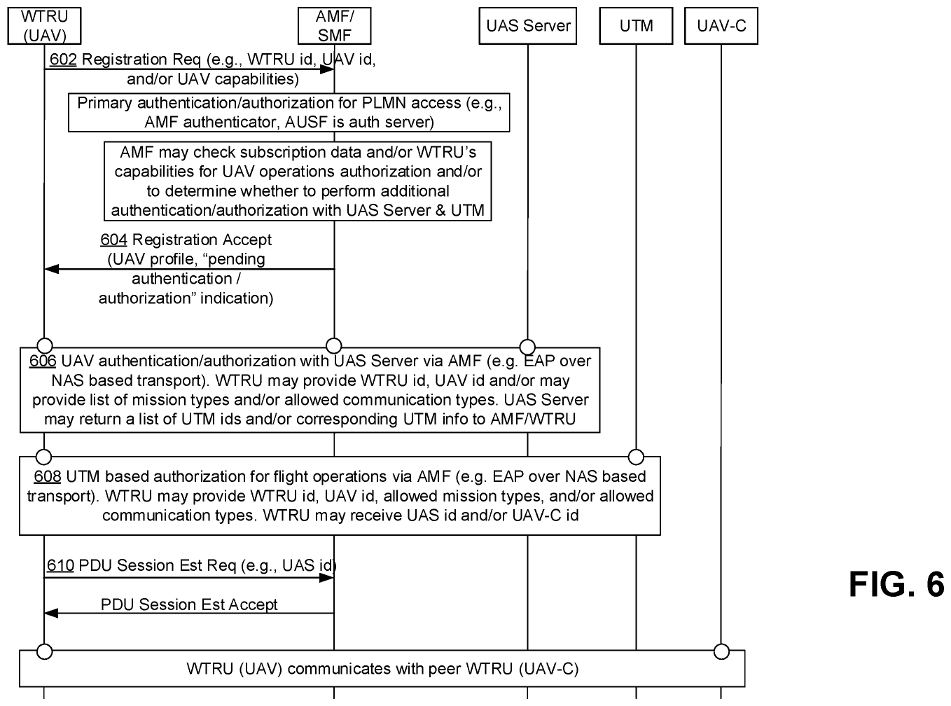

FIG. 6 illustrates an example of EAP based authentication and/or authorization by a UAS server and/or a UTM with an AMF as authenticator. An AMF may communicate with a UAS Server and/or a UTM, for example, via a proxy function (e.g., in the 5GC).

A WTRU (e.g., UAV) may send a registration request message, for example, during initial registration. As shown in FIG. 6, at 602, the WTRU may send a registration request message, which may include, for example, one or more of its WTRU id, UAV id, UAV capabilities, and/or the like. The UAV id may be security protected. The UAV id may be sent during the registration procedure, for example, once (e.g., after) security protection is established. WTRU (e.g., UAV) capabilities, such as information regarding WTRU (e.g., UAV) support for communication capabilities designed for UAS operation may be provided (e.g., in a registration request message).

A WTRU may perform primary authentication/authorization for network access and/or security establishment (e.g., security mode command (SMC)) procedures. As shown by example in FIG. 6, at 602, a WTRU may perform a primary authentication/authorization for PLMN access (e.g., with an AMF as authenticator and/or an authentication server function (AUSF) as an authorization server). The network (e.g., via an AMF) may obtain a WTRU profile (e.g., via the UDM). As shown by example in FIG. 6, at 602, an AMF may check subscription data, a UAV id in the registration request message, and/or a WTRU's capabilities for UAV operations authorization and/or to (e.g., determine whether to) perform additional authentication/authorization with a UAS server and/or a UTM. The network (e.g., via an AMF) may validate that UAS functionality is allowed. The network (e.g., via an AMF) may reply with a registration accept message, which may include, for example, one or more of a UAV profile, an indication (e.g., a code), and/or the like. An AMF may reply with a registration accept message including, for example, a type of communication allowed, a list of allowed mission types, and/or a code set to “additional authentication/authorization pending.”

A WTRU (e.g., UAV) may receive a registration accept message (e.g., during initial registration). A registration accept message may include, for example, an indication for pending additional authentication/authorization and/or the like. As shown by example in FIG. 6, at 604, a WTRU may receive a registration accept message including, for example, an indication for a pending authentication/authorization and/or a UAV profile. An AMF may maintain the signaling connection. The signaling connection may be maintained by AMF, for example, to trigger a UAV authentication/authorization procedure (e.g., immediately) following a WTRU registration procedure.

A WTRU (e.g., UAV) may engage in a follow-on authentication/authorization procedure. A follow-on EAP authentication/authorization procedure may include, for example, exchanging EAP messages between a WTRU and a UAS server. A WTRU may exchange EAP messages with UAS Server, for example, via an AMF. A WTRU may provide (e.g., in one or more messages) a list of allowed mission types and/or allowed communication types. An AMF may include (e.g., in an EAP message towards the UAS server), for example, a WTRU id and a UAV id. A WTRU may receive an EAP success message. An EAP success message may include an indication to pursue authorization with a UTM. A WTRU may receive a list of UTM ids (e.g., with corresponding UTM information). In examples, a list of UTM ids and/or corresponding UTM information may be sent (e.g., from a UAS server) to the AMF. The AMF may push the list of UTM ids and/or corresponding UTM information to the WTRU (e.g., via UCU procedure). As shown by example in FIG. 6, at 606, a WTRU (e.g., UAV) may engage in UAV authentication/authorization with a UAS server via AMF (e.g., EAP over NAS based transport). The WTRU may provide, for example, a WTRU id, a UAV id, a list of mission types and/or allowed communication types. The UAS Server may return a list of UTM ids and/or corresponding UTM information to the WTRU (e.g., via the AMF).

A WTRU (e.g., UAV) may exchange EAP messages with a UTM (e.g., during follow-on EAP authentication/authorization), for example, for flight operations. A WTRU may exchange EAP messages with a UTM via an AMF. In examples, multiple iterations (e.g., of messages) may occur. A WTRU may provide, for example, its WTRU id, a UAV id, a list of allowed mission types, allowed communication types and/or (e.g., if available), the identifier of a target peer WTRU (UAV-C) for the WTRU (e.g., UAV).

An AMF may send a message towards the UTM. An AMF message towards the UTM may include, for example, information received from the WTRU (e.g., in an EAP message). The WTRU may receive an EAP success (or failure) message from the USS/UTM, for example, via the AMF and/or a proxy function (e.g., in the 5GC). The signaling connection may be released by AMF, for example, if the target peer WTRU (e.g., UAV-C) has not (e.g., yet) been authorized by the UTM. The WTRU may be paged, for example, if the target peer WTRU (e.g., UAV-C) has not been authorized, if the signaling connection is released, and/or otherwise prior to further action. The WTRU may receive a UAS id and/or a target peer WTRU (e.g., UAV-C) id during a UCU procedure, for example, if an EAP authentication is successful and/or the WTRU is authorized for UAS flight operations by the UTM. The WTRU may store the UAS id and/or UAV-C id, for example, in a local configuration. As shown by example in FIG. 6, at 608, the WTRU (e.g., UAV) may engage in UTM based authorization for flight operations via AMF (e.g. EAP over NAS based transport). At 608, the WTRU may provide, for example, a WTRU id, a UAV id, allowed mission types and/or allowed communication types. The WTRU may receive a UAS id and/or a UAV-C id.

A WTRU (e.g., UAV) may set up and/or engage in C2 communications. A WTRU (e.g., UAV) may set up C2 communications, for example, by setting up a PDU session. The WTRU may set up a PDU session for C2 communications with target peer WTRU (e.g., UAV-C). The WTRU may send a PDU session establishment request message, which may include a UAS id. A UAV-C type of WTRU may be involved (e.g., utilized) with one or more UAV type of WTRUs. A UAS id may be useful, for example, if the UAV-C may be associated simultaneously with multiple UAVs (e.g., multiple UAS ids). The network may check/enforce authorization, for example, for C2 communications (e.g., using the provided UAS id). As shown in FIG. 6, at 610, the WTRU may send a PDU session establishment request. At 610, the AMF may send a PDU session establishment accept message. The WTRU (e.g., UAV) may communicate with its peer WTRU (e.g., UAV-C). The WTRU may set up a PDU session for communications with the UTM.

A WTRU (e.g., UAV) may (e.g., additionally and/or alternatively) perform a registration or service request, for example, with an available UAS id. Performing a registration or service request may be in addition or alternative to performing one or more aspects of EAP based authentication and/or authorization with an AMF as an authenticator. A WTRU (e.g., UAV) may have an assigned UAS id, for example, when resuming a flight mission after a waypoint stop. A WTRU (e.g., with an available UAS id) may, for example, send a registration request (RR) and/or a service request (SR) message. The WTRU may perform EAP authentication (e.g., as described herein), for example, following a registration accept (RA) and/or a service accept (SA) or may skip EAP authentication (e.g., if the available UAS id is still valid). The WTRU may receive (e.g., in an RA and/or an SA message) a different UAS id and/or a target peer WTRU (e.g., UAV-C) id.

In examples, a WTRU may send an RR/SR message including, for example, an (e.g., available) UAS id (e.g., from a prior UAS authorization). The WTRU may perform EAP authentication (e.g., as described herein), for example, following an RA/SA, which may include a pending authentication/authorization by a UAS server and/or by a UTM. The WTRU may skip EAP authentication, for example, if a UAS id authorization is still valid (e.g., as per authorization information stored in the AMF). For example, the WTRU may receive an RA/SA message that does not include a pending authentication/authorization indication. The WTRU may receive (e.g., in an RA/SA message) a different (e.g., updated or replacement) UAS id and/or a target peer WTRU (e.g., UAV-C) id. The WTRU may store the UAS id and/or UAV-C id, for example, in a local configuration. The WTRU may replace a prior UAS id and/or UAV-C id with the different identifiers.

EAP based authentication and/or authorization may be performed by a UTM and/or other entities/functionalities, for example, with an SMF as authenticator. A network may (e.g., be enabled to) pair multiple (e.g., two) WTRUs. In an example, an SMF may be enabled to pair a UAV and UAV-C for (e.g., to enable and/or support) C2 communications. The UTM may be associated with a DN. The UTM may act as a DN-AAA server and/or may be in communication with a DN-AAA server.

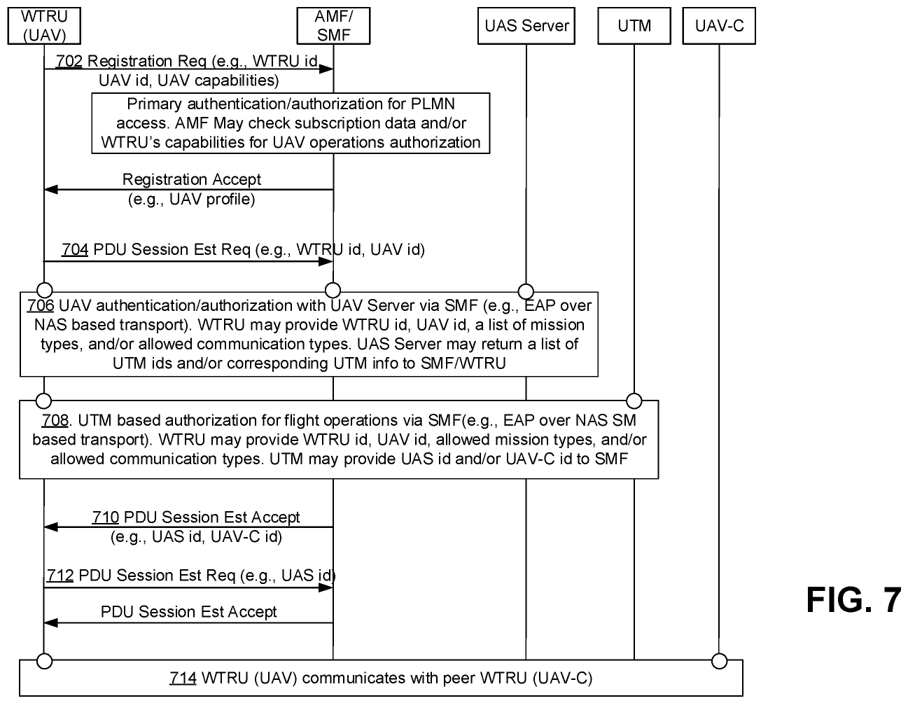

FIG. 7 illustrates an example of EAP based authentication and/or authorization by a UTM, for example, with an SMF as an authenticator. An SMF may communicate with a UTM (e.g., directly or via UPF). For example, an SMF may communicate with a UTM (e.g., directly) over a control plane (e.g., with the UTM being part of 5GC) or via a NEF, or (e.g., indirectly) via UPF (e.g., with the UTM being external to 5GC).

A WTRU (e.g., UAV) may perform a registration procedure with a network. A WTRU may perform a registration procedure with a network based on one or more of its WTRU id, UAV id, and/or UAV capabilities. As shown by example in FIG. 7, at 702, a WTRU may send a registration request, which may include one or more of its WTRU id, UAV id, and/or UAV capabilities. The UAV id may be security protected. The UAV id may be sent during the registration procedure, for example, once (e.g., after) the security protection is established. UAV capabilities (e.g., provided in the registration request) may include information about WTRU (e.g., UAV) support for communication capabilities for UAS operation. At 702, primary authentication/authorization may be provided for PLMN access. At 702, the AMF may check subscription data and/or the WTRU's capabilities for UAV operations authorization. The network (e.g., via an AMF) may obtain the WTRU profile (e.g., via the UDM). The network (e.g., via an AMF) may confirm/validate that UAS functionality is allowed. The AMF may reply with a registration accept message, which may include a UAV profile (e.g., a type of communication allowed, a list of allowed mission types, and/or the like).

The WTRU (e.g., UAV) may send a PDU session establishment request. As shown by example in FIG. 7, at 704, the WTRU may send a PDU session establishment request, which may include its WTRU id and/or a UAV id.

A WTRU (e.g., UAV) may exchange EAP messages with a UAS Server, for example, via an SMF (e.g., during a session establishment and/or an EAP authentication/authorization procedure). An SMF may send an EAP message to (e.g., towards) a UAS server. The message may include one or more WTRU identifiers (e.g., WTRU id, UAV id). The WTRU may receive an EAP success message, which may include an indication to pursue authorization with a UTM. The UAS server may send a list of UTM ids and/or corresponding UTM information to the SMF (e.g. via UPF). The AMF may push the list of UTM ids and/or corresponding UTM information to the WTRU (e.g., via a UCU procedure). As shown by example in FIG. 7, at 706, UAV authentication/authorization with a UAV server, for example, via an SMF (e.g. EAP over NAS based transport). At 706, the WTRU may provide, for example, a WTRU id, a UAV id, a list of mission types, and/or allowed communication types. A UAS Server may return a list of UTM ids and/or corresponding UTM information to SMF and/or WTRU (e.g., via the SMF).

The WTRU (e.g., UAV) may exchange EAP messages with UTM (e.g., via SMF), for example, during PDU session establishment and/or EAP authentication/authorization. Multiple iterations (e.g., of messaging) may occur. The WTRU may provide (e.g., in a message) its WTRU id, a UAV id, a list of allowed mission types, allowed communication types, and/or (e.g., if available) the identifier of its target peer WTRU (e.g., UAV-C). An SMF may send an EAP message to (e.g., towards) a UTM. The message may include one or more WTRU identifiers (e.g., WTRU id, UAV id), the list of allowed mission types, allowed communication types, and/or (e.g., if available) the identifier(s) of the target peer WTRU (e.g., UAV-C). The WTRU may receive an EAP success (or failure) message. The UTM may inform the SMF and/or provide a different UAS id and/or a target peer WTRU id, for example, if EAP authentication is successful and the WTRU is authorized for UAS flight operations by the UTM. The result of successful authentication/authorization by UTM may be stored, for example, in or by the SMF and/or UDM. As shown in FIG. 7, at 708, UTM based authorization for flight operations may be implemented, for example, via SMF (e.g. EAP over NAS session management (SM) based transport). At 708, the WTRU may provide, for example, a WTRU id, a UAV id, allowed mission types, and/or allowed communication types. The UTM may provide a UAS id and/or a UAV-C id to the SMF.

A WTRU (e.g., UAV) may receive identifiers (e.g., during registration, EAP authentication/authorization and C2 communication). As shown by example in FIG. 7, at 710, the WTRU may receive one or more identifiers (e.g., UAS id, UAV-C id) in a PDU session establishment accept message. The PDU session may be successfully established. In some examples, the WTRU may not be authorized for flight operation, for example, pending a UAV-C being authorized by a UTM to fly the WTRU (e.g., UAV), which may be implemented, for example, by an alternative EAP authentication/authorization (e.g., as described herein).

A WTRU (e.g., UAV) may modify a current/established PDU session and/or set up a different PDU session (e.g., for C2 communication) with a target peer WTRU (e.g., UAV-C). The WTRU may include the UAS id in the PDU session establishment request message, for example, if a different PDU session is set up. As shown by example in FIG. 7, at 712, the WTRU may send a PDU session establishment request. At 712, the AMF may send a PDU session establishment accept. A UAV-C may be involved (e.g., simultaneously) with multiple UAVs. The UAS id may be used in the PDU session establishment request, for example, to distinguish between multiple UASs. The network may check/enforce authorization for C2 communications, for example, using the UAS id (e.g., provided in the PDU session establishment request message).

A WTRU (e.g., UAV) may communicate with a peer WTRU (e.g., UAV-C). As shown by example in FIG. 7, at 714, the WTRU (e.g., UAV) may communicate with its peer WTRU (e.g., UAV-C), for example, using the different or modified PDU session.

A WTRU (e.g., UAV) may complete EAP initial authentication (e.g., as described herein) without being provided a UAS id. A WTRU (e.g., without a UAS id) may engage in (e.g., alternate) EAP authentication/authorization. The WTRU may receive a PDU session establishment accept message. The WTRU may receive a PDU session modification command. The WTRU may proceed with C2 communications. In examples, a WTRU (e.g., UAV) performing PDU session modification may be an alternative to or different option from performing certain aspects of EAP based authentication and/or authorization with SMF as authenticator.

A WTRU (e.g., UAV) may have completed the EAP initial authentication (e.g., as described herein) without being provided a UAS id (e.g., in the PDU session establishment accept message). For example, the WTRU may have been successfully authenticated by the UTM but may not be authorized for flight operations, e.g., in the absence of an authorized peer WTRU (e.g., UAV-C).

In examples, a WTRU (e.g., UAV) may receive a PDU session establishment accept message with a code specifying, for example, “Final authorization pending.” The WTRU may (e.g., in response to the message) wait for authorization from a UTM (e.g., similar to 710 in FIG. 7).

A WTRU (e.g., UAV) may receive a PDU session modification command, which may include a different UAS id and/or a target peer WTRU (e.g., UAV-C). The WTRU may perform an EAP re-authentication with the UTM (e.g., via SMF), for example, before the WTRU receives a PDU session modification command. The EAP re-authentication may be, for example, a fast EAP re-authentication. The PDU session modification procedure may be triggered by the UTM. The PDU session modification procedure may be triggered by the UTM, for example, if and/or when notifying the SMF of an authorization update.

The WTRU may proceed with C2 communication-related operations, for example as described herein (e.g., 712, 714 in FIG. 7).

A UAS may include entities and/or functions that are configured to perform re-authorization, for example, upon an event (e.g., after an expiration of an authorization period). A UAS may include entities and/or functions that are configured to perform revocation of prior authentication, for example, upon an event. A UAS may include entities and/or functions that are configured to respond, for example, upon an authorization failure.

In examples, a WTRU may perform network authentication. A WTRU may perform a first (e.g., a primary) authentication with a network (e.g., a RAN, such as 5G RAN). Network authentication may be performed, for example, to verify the WTRU's identity. For example, an authenticated WTRU may be allowed access to a core network (e.g., NR core network). The WTRU may receive a UAV profile, for example, upon authentication with the network. The WTRU may perform a second (e.g., a secondary) authentication (e.g., with a UAS server), for example, using the UAV profile. UAS authentication may be performed, for example, to verify the UAV's identity and/or to authorize the UAV. The WTRU may receive authorization for a UAS communication service (e.g. to perform flight operations).

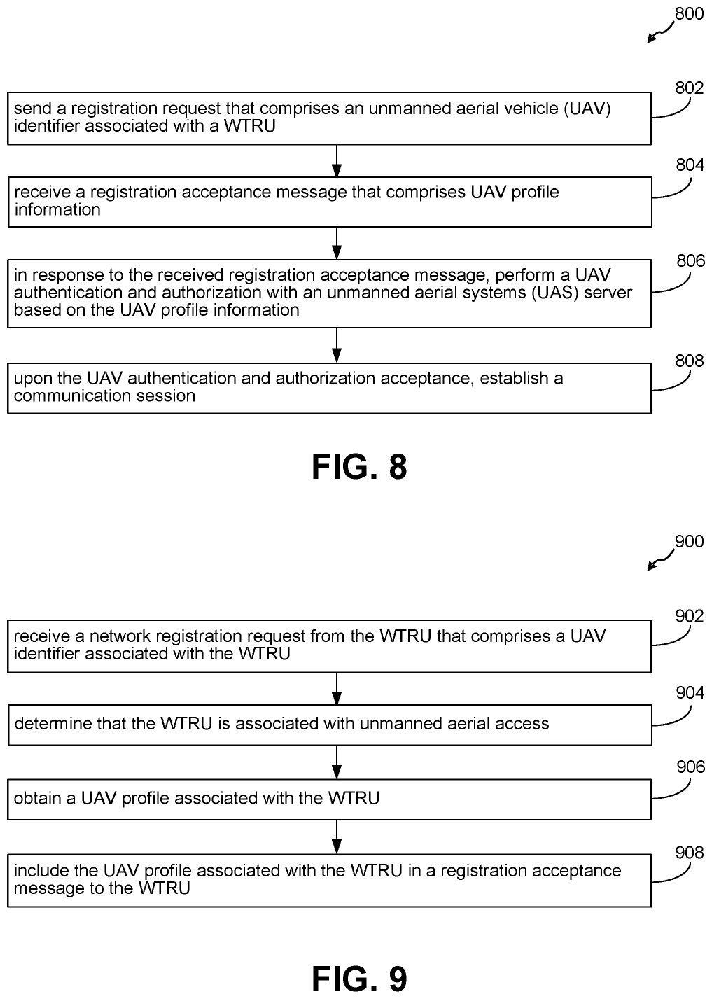

FIG. 8 illustrates an example of a method for performing UAV authentication and authorization. Examples disclosed herein and other examples may operate in accordance with example method 800 shown in FIG. 8. Method 800 comprises 802 through 808. In 802, a registration request that comprises a UAV identifier associated with a WTRU may be sent. In 804, a registration acceptance message that comprises UAV profile information may be received. In 806, a UAV authentication and authorization may be performed with a UAS server based on the UAV profile information, for example, in response to the received registration acceptance message. In 808, a communication session may be established, for example, upon the UAV authentication and authorization acceptance.

FIG. 9 illustrates an example of a method for performing UAV registration. Examples disclosed herein and other examples may operate in accordance with example method 900 shown in FIG. 9. Method 900 comprises 902 through 908. In 902, a network registration request may be received from a WTRU. The request may comprise a UAV identifier associated with the WTRU. In 904, a determination may be made that the WTRU is associated with unmanned aerial access. In 906, a UAV profile associated with the WTRU may be obtained. In 908, the UAV profile associated with the WTRU may be included in a registration acceptance message to the WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-32. (canceled)

33. A wireless transmit/receive unit (WTRU), comprising:
a processor configured to:
send a first message to a base station, wherein the first message indicates a vehicle identifier;
receive a second message from the base station, wherein the second message indicates that the vehicle identifier has been authenticated and indicates vehicle profile information; and
send a third message to the base station responsive to the received second message, wherein the third message indicates a request to establish a communication session based on the vehicle profile information.

34. The WTRU of claim 33, wherein the vehicle profile information comprises at least an allowed mission type, an allowed communication type, or a vehicle controller identifier.

35. The WTRU of claim 33, wherein the first message is a protocol data unit session (PDU) establishment request message.

36. The WTRU of claim 33, wherein the second message is associated with a protocol data unit (PDU) session authentication procedure.

37. The WTRU of claim 33, wherein the second message is a protocol data unit (PDU) session accept message.

38. A method performed by a wireless transmit/receive unit for requesting a communication session, the method comprising:
sending a first message to a base station, wherein the first message that indicates a vehicle identifier;
receiving a second message from the base station, wherein the second message indicates that the vehicle identifier has been authenticated and indicates vehicle profile information; and
sending a third message to the base station responsive to the received second message, wherein the third message indicates a request to establish a communication session based on the vehicle profile information.

39. The method of claim 38, wherein the vehicle profile information comprises at least an allowed mission type, an allowed communication type, or a vehicle controller identifier.

40. The method of claim 38, wherein the first message is a protocol data unit session (PDU) establishment request message.

41. The method of claim 38, wherein the second message is associated with a protocol data unit (PDU) session authentication procedure.

42. The method of claim 38, wherein the second message is a protocol data unit (PDU) session accept message.

43. A base station, the base station comprising:
a processor configured to:
receive a first message from a wireless transmit/receive unit (WTRU), wherein the first message indicates a vehicle identifier;
send a second message to the WTRU, wherein the second message indicates that the vehicle identifier has been authenticated and indicates vehicle profile information; and
receive a third message from the WTRU responsive to sending the second message, wherein the third message indicates a request to establish a communication session based on the vehicle profile information.

44. The base station of claim 43, wherein the vehicle profile information comprises at least an allowed mission type, an allowed communication type, or a vehicle controller identifier.

45. The base station of claim 43, wherein the first message is a protocol data unit session (PDU) establishment request message.

46. The base station of claim 43, wherein the second message is associated with a protocol data unit (PDU) session authentication procedure.

47. The base station of claim 43, wherein the second message is a protocol data unit (PDU) session accept message.
